(19) United States
(12) Patent Application Publication
(10) Pub. No.: US 2004/0107918 A1
(43) Pub. Date: Jun. 10, 2004

(54) Pendulous mobile animal amusement/exercise apparatus

(76) Inventor: Allan Lyle Cox, Gladstone (CA)

Correspondence Address: ALLAN L. COX, PO Box 8, 26 Dennis St. W, Gladstone, MB, R0J 0T0, CA

(21) Appl. No.: 10/698,557

(22) Filed: Nov. 3, 2003

Related U.S. Application Data
(60) Provisional application No. 60/424,429, filed on Nov. 6, 2002.

(51) Int. Cl. A01K 29/00

(52) U.S. Cl. 119/708

(57) ABSTRACT

A pendulous mobile animal amusement/exercise apparatus is disclosed; a rigid pendulum like member comprising a single arm constructed of two oblique, distally merged limbs, a load element attached proximate the lower distal end and a sway/swivel mechanism fastened proximate the upper distal end. It is securely suspended from above via the sway/swivel, attached by suitable mechanism to a rigid form such as the ceiling of a dwelling, or any other appropriate unyielding structure. A reciprocal actuator medium comprised of a shorter similar limb, with a distally attached resilient cord extending vertically downward, is affixed about said limbs free distal end to said pendulum like member intermediately and distally disposed the load mass and point of suspension. A toy/target of suitable nature to attract the particular animal is secured to the lower free end of said cord, within reach of the animal.

### CROSS-REFERENCE TO RELATED APPLICATIONS

This application claims the benefit of U.S. Provisional Application No. 60/424,429 filed Nov. 4, 2002.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates generally to amusement/exercise devices developed for animals that hunt or play; including, but not exclusively for cats and dogs and pertains more particularly to, erratic mobile type devices intended by action to retain the interest and interaction of the animal for extended periods of time, thereby providing them amusement and exercise.

An abundant variety of contrivances designed to amuse and exercise animals particularly pets such as cat and dogs, exists in prior art. This in itself demonstrates the need for such devices. It is also clear that the desired action of devices developed for this objective, be capable of producing complex, erratic and substantially prolonged three dimensional target movements.

Such contrivances may include a range of complicated electromechanical machines to devices as simplistic as a suspended elastic cord and with target attached. They can be multifaceted and elaborate and may include motors and driver circuits, gears or pulleys, incorporating motion sensors and the like, requiring batteries or other forms of electromotive force to function. These involved machines may have the capacity to produce the desired qualities of action, however they inherently emit unnatural sounds that can frighten or repel the animal.

A number of the more basic relatively silent assemblages presented in prior art, may include devices such as an elastic cord attached to a suspended clamp of sorts, and are physically incapable of producing any notably sustained or prolonged erratic target movement.

Other more complex mobile type devices may include one or more tethered ballasted rods or shafts that generally, as a requirement of function; are suspended at a height that is in the way of, and poses a potential injury hazard to, persons passing through the area.

A number of these devices require human manipulation to function. Although person/pet interaction is a positive feature, the requirement of human manipulation is limiting in nature, as it restricts device activity to the persons scheduling.

Accordingly, the need exists in the industry to address the aforementioned deficiencies and inadequacies.

### BRIEF SUMMARY OF THE INVENTION

It is an object of the present invention to provide an apparatus for the amusement and exercise of animals that hunt or play, including pets such as cats and dogs.

Additionally it is an object of the present invention is to provide a device capable of producing the aforementioned desirable target movements without the need for noisy complicated machinery or human manipulation.

Another object of the present invention is to provide a device that even though does not require human manipulation, does allow for human interaction with both device and animal when so desired.

Still another object of the present invention is to provide a device that is suspended from above, up out of the way, of persons passing through the area.

In fulfillment of the aforementioned objectives among others, the present invention is provided, adapted in the manor of a suspended gravitationally responsive animal actuated pendulous mobile apparatus inherently facilitating complex, erratic and substantially prolonged three dimensional target movements that vary in both tempo and bearing.

Further, the novel features and advantages of the present invention may be more clearly understood by reference to the subsequent written description of preferred embodiments in conjunction with the accompanying drawings.

### BRIEF DESCRIPTION OF THE SEVERAL VIEWS OF THE DRAWING

All drawings, as furnished, encompass preferred embodiments of best mode as contemplated and practiced by the inventor.

NOTE: In FIG. 1 through FIG. 3 the item labeled 100 is representative of the device or structure, of the apparatus inclusive of all components exempt only of elements 8 and 9.

FIG. 1 is a schematic view of one embodiment of the present invention illustrating relative movement and a sample application.

FIG. 2 is a static elevational side view of one embodiment of the present invention.

FIG. 3 is a static elevational rear view of device 100 of the embodiment of the present invention, illustrated in FIG. 2.

FIG. 4 is an enlarged sectional view of end portion 27 of shaft 3 of the embodiment of the present invention, illustrated in FIG. 2.

FIG. 5 is an enlarged sectional view of end portion 11 of shaft 1 of the embodiment of the present invention, illustrated in FIG. 2.

FIG. 6 is an enlarged exploded side view of end portion 18 of shaft 2 of the embodiment of the present invention, illustrated in FIG. 2.

### DETAILED DESCRIPTION OF THE INVENTION

Exemplary embodiments of the present invention are hereinafter described in detail in conjunction with the aforementioned drawings.

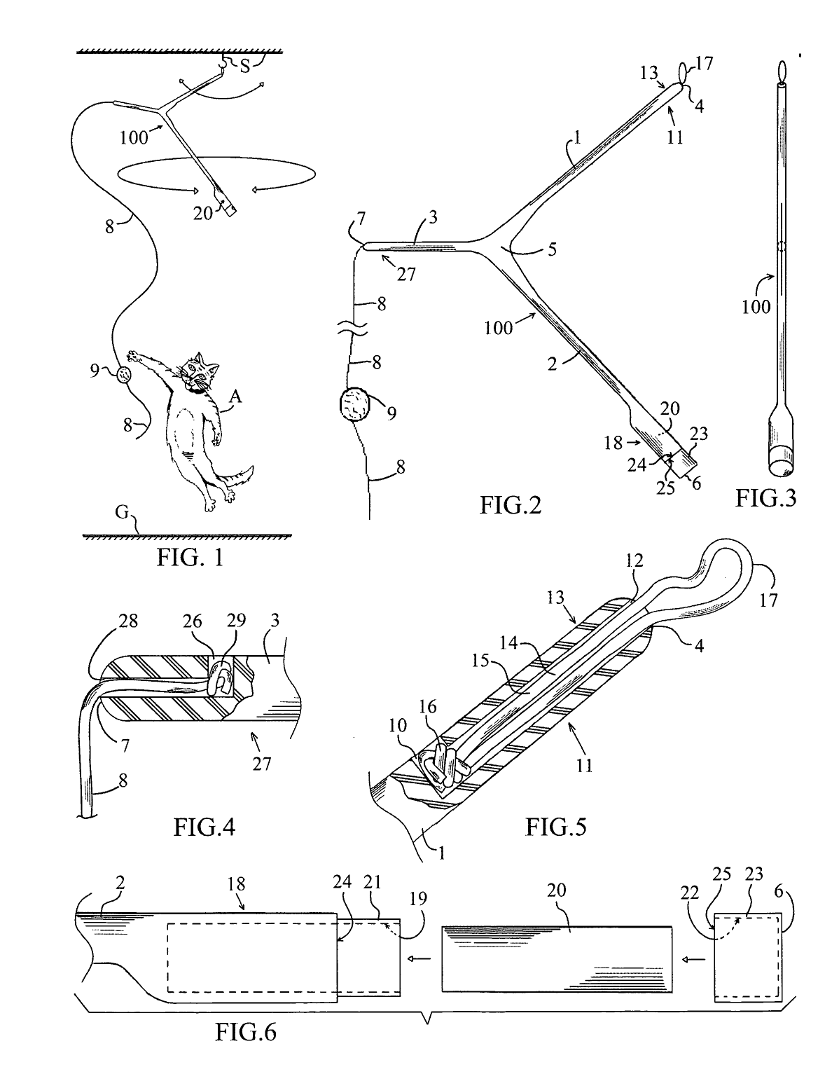

FIG. 1 illustrates a sample application including the relative movement of the apparatus and will be best understood and described in detail following the presentation of the features illustrated by FIG. 2 through FIG. 6 of the drawings. In reference to FIG. 2, items 1, 2, 3 and 5 are of a relatively low mass, rigid material united by suitable means. Upper item 1 begins at, is secured to, and inclines away from central union 5 extending to distal end 4 in relative posture to items 2 and 3 as illustrated. Lower item 2 begins at, is secured to, and declines away from central union 5 extending to distal end 6 in relative posture to items 1 and 3 as illustrated. Item 3 begins at, is attached to, and extends away from central union 5, to distal end 7 bearing away from items 1 and 2.

The entire apparatus is suspended from above via an appropriate support medium 17 secured to a class of sway/swivel mechanism 13 affixed to end portion 11 of item 1. Said support medium 17 in conjunction with sway/swivel mechanism 13 must incorporate characteristics designed to minimize any horizontal deflection of distal end 4 of item 1, away from the vertical of the peak of suspension.

A finite length of resilient flaccid cord 8 of apposite form and dimension is attached by one free end and by suitable means to item 3 at distal end 7, extending vertically downward terminating proximate the floor or ground G (see FIG. 1). An object 9, of relatively low mass and appropriate dimension being of fitting nature to be attractive to the particular animal, is fastened to cord 8 in proximity to the lower unbound terminate end of cord 8 at an appropriate height. Object 9 hereinafter is referenced solely as target 9, represents the toy/target of the apparatus.

Continuing with FIG. 2, a load member 20 of appropriate mass in suitable form is attached to lower item 2 in proximity of distal end 6. Load member 20 is of sufficient mass as to present apposite gravitational bias through the structure 100 to support the weight of attached cord 8 and target 9, while effectively positioning item 3 in an approximate horizontal attitude as illustrated.

Best mode as contemplated and carried forth by the inventor is declared as follows. Items 1, 2, and 3 henceforth are referenced to as shaft 1, shaft 2, and shaft 3 respectively; as applicable in the preferred embodiment of this invention. Shafts 1, 2, and 3 along with central union 5 are combined into a rigid one piece injection molded polymeric unit of configuration as depicted in FIG. 2 and FIG. 3.

Excluding end portion 18 of shaft 2, each of the three shafts is of a small diameter, amalgamating at central union 5. Shafts 1 and 2 are of similar length.

Shaft 3 is of lesser length than that of 1 and 2.

FIG. 4 demonstrates the preferred embodiment employed to secure resilient cord 8 to distal end 7 of shaft 3. Cavity 26 is molded into end portion 27 of shaft 3. A smaller diameter hole 28 is provided thru distal end 7 into opening 26. One free end of cord 8 is passed from distal end 7 thru hole 28, out opening 26. A knot 29 is formed in said protruding free end of cord 8 so that it is larger than the diameter of hole 28, but smaller than opening 26. Cord 8 is pulled back through hole 28 until knot 29 recedes into cavity 26, thereby securing cord 8 in the previously described location in addition to concealing knot 29 within opening 26. This feature also provides means for altering the overall length of cord 8 to suit the individual height variations of different installation locations.

Target 9 is attached, and is of form, as previously described being selected accordingly to suit the characteristics of the particular animal class that it is intended to attract.

FIG. 5 illustrates the form and manner of sway/swivel mechanism 13 implemented in the preferred embodiments of the present invention. Cavity 10 is molded into end portion 11 of shaft 1. A smaller diameter hole 12 is installed thru distal end 4 of shaft 1 into opening 10. A length of flaccid robust cord 14 of suitable material and dimension is fashioned into a closed loop 15 by tying together the two distal ends of cord 14 into knot 16 and positioning it opposite the loop end 17. Knot 16 is of smaller dimension than opening 10 and larger than the diameter of hole 12. Loop end 17 is inserted into opening 10 passed through hole 12, out distal end 4 of shaft 1. The loop end 17 is pulled thru to the point at which knot 16 is fully inserted into and concealed within opening 10. Hole 12 is of large enough diameter as to allow the two strands of cord 14 that make up loop 15 to twist freely about each other within end portion 11 of shaft 1, thereby permitting the entire unit to swivel.

Closed loop 15 with loop end 17 now protruding from distal end 4, has a three fold purpose in that it furnishes sway and swivel capacities as well as providing a support medium utilized to suspend the device from above.

FIG. 6 depicts the form and manner preferred to attach a load mass 20 proximate distal end 6 of shaft 2. Within end portion 18 of shaft 2 hollow 19 is provided and is of necessary dimension as to allow load member 20 to be inserted fully within. Collar 21 is of proper dimension to allow cavity 22 of end cap 23 to slide snugly over it into position whereby edge 24 and 25 fit securely together, thereby enclosing load member 20 within end portion 18 of shaft 2. Cap 23 is secured by appropriate means.

Referring back to FIG. 1, a pendulous mobile animal amusement and exercise apparatus is provided, comprised of suspended device 100, with attached resilient cord 8 and target 9. When the animal A tugs on resilient cord 8 or target 9 the applied torque is transferred through device 100 to structure S. As structure S is unyielding the applied torque is reflected back through the assembly effecting swinging movement of the entire apparatus, causing enclosed load mass 20 to rise against the pull of gravity. The gravitational forces exerted on load member 20 inherently reciprocate through the structure 100 in opposition to any force exerted on resilient cord 8. This effect engages the animal with the sensation of the cord 8 and target 9 tugging back. As the animal releases said elements, the gravitational forces exerted on enclosed load mass 20 inherently strives to return structure 100 to its static position, thereby causing it to swing to and fro and/or side to side for an extended period of time; as well as freely rotating up to and beyond 360 degrees in either direction along an approximate horizontal plane. As attached cord 8 and target 9 present a measurable mass and are free to swing about three dimensionally, the gravitational force exerted on them being in opposition to the gravitational force exerted on load member 20, has the effect of causing the device 100 to rotate and flip about in an erratic manor. Correspondingly device 100 now in motion, transfers its inertial force, back to cord 8 and target 9, substantially sufficient to provide prolonged action motion to said elements in a manner of erratic up and down, side to side and circular three dimensional movements, thereby increasing the attraction capacity of same to the animal.

While the inventor has fully disclosed and laid illustration to the preferred embodiments of the present invention it is exemplary and not intended that it be limiting thereby and that certain modifications of features thereof may be introduced without departing from the true spirit and scope of the invention.

What the inventor claims as his invention is:

1. A pendulous mobile animal amusement and exercise apparatus comprising:
a rigid pendulum like member with distally affixed load mass suspended via attached sway/swivel mechanism secured to upper end portion of said rigid pendulum like member;
incorporating a reciprocal actuator medium of adapted form secured to said rigid pendulum like member, intermediately and distally disposed the load mass and point of suspension.
